(19) United States
(12) Patent Application Publication
(10) Pub. No.: US 2025/0347163 A1
(43) Pub. Date: Nov. 13, 2025

(54) HINGE

(71) Applicant: MTec Manufacturing, LLC, Sturgis, MI (US)

(72) Inventors: Tyler A. BOURASSA, Sturgis, MI (US); Mickeal L. DELAVEAU, Constantine, MI (US); Wade R. WOLF, White Pigeon, MI (US)

(21) Appl. No.: 19/199,739

(22) Filed: May 6, 2025

Related U.S. Application Data
(60) Provisional application No. 63/643,637, filed on May 7, 2024.

(51) Int. Cl. E05F 1/12; E05D 3/02

(52) U.S. Cl. CPC E05F 1/1207; E05D 3/02; E05Y 2900/516; E05Y 2900/544

(57) ABSTRACT

A hinge for a trailer ramp door or a truck box ramp door is provided. The hinge has a centralized rod and one or more attachment members for attaching the hinge to the ramp door.

### CROSS-REFERENCE TO RELATED APPLICATON

This claims the benefit of U.S. Provisional Application No. 63/643 637, filed May 7, 2024, the disclosure of which is hereby incorporated by reference in its entirety.

### FIELD OF THE INVENTION

This relates generally to adjustable hinges, and more specifically to ramp hinges.

### BACKGROUND AND SUMMARY OF THE INVENTION

Ramps are inclined surfaces to roll or carry items up and down from one level to another. Trailers which are attached to vehicles often include a ramp to assist in loading and unloading items onto and off of the trailer, between the trailer bed and the ground. Sometimes a trailer ramp acts as a door or gate, often referred to as a “ramp door,” especially in the case of an enclosed trailer. Such trailer ramps are typically located at the rear of the trailer, but may also be located at the front of the trailer or on the side.

Ramps that act as a permanent part of the trailer are typically pivotally attached to the frame or housing of the trailer via a hinge. Thus, the ramp may be moved manually from a lowered, loading position to an upper, raised position and vice versa. The ramp may also include a latch or other connection system to hold the ramp in place when in the raised position.

A trailer ramp must support the weight of the load being conveyed thereon. The material of the ramp surface is important because it dictates how much weight the ramp can handle and its overall longevity. But the pivot apparatus and any other attachment structure must also be able to stand up to the load which is being brought onto or taken off of the trailer. To account for this, many trailer ramp hinges have become more robust and heavier in the process. However, a common trailer hinge, which is similar to a standard door or box hinge, provides no assistance in lowering or raising a ramp, which may be very heavy.

The inventors herein invented a means by which a connection and pivot structure for a trailer ramp holds up to heavy loads while assisting with lowering and raising the ramp.

One aspect and embodiment of the present invention is a hinge comprising a housing defining an interior space, the housing comprising at least one wall member having an exterior surface and an interior surface. The hinge further comprises at least one outer member adjacent the housing and having an aperture therethrough, and a centralized rod, a portion of which resides in the interior space of the housing and extends to and through the aperture of the outer member. The hinge also comprises a plurality of torsion springs in the interior space of the housing and which are connected to the rod, and at least one fastener configured to adjust the tension in at least one of the plurality of torsion springs.

Another aspect and embodiment of the present invention is a trailer ramp connection apparatus comprising a central rod, at least one spring in torsional engagement with the central rod, and an adjustable device comprising a rotatable member and connected to the at least one spring. Rotation of the rotatable member changes the torsion in the at least one spring. The trailer ramp connection apparatus further comprises a connection member connected to the central rod and configured to attach to or receive a portion of a trailer.

Yet another aspect and embodiment of the present invention is a vehicle trailer comprising a frame, a ramp member connected to the frame, and a hinge. The hinge comprises a central rod, at least one spring in rotational engagement with the central rod, an adjustment device for adjusting tension of the at least one spring, and a connection member connected to the central rod. The connection member is in engagement with the frame or the ramp member.

BRIEF DESCRIPTION OF THE DRAWING FIGURES

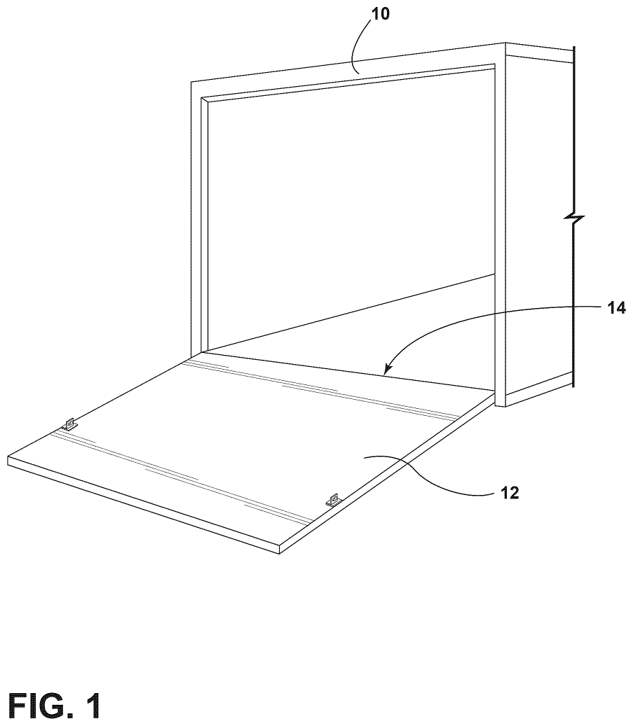

FIG. 1 is a perspective view of a portion of a trailer having a ramp door.

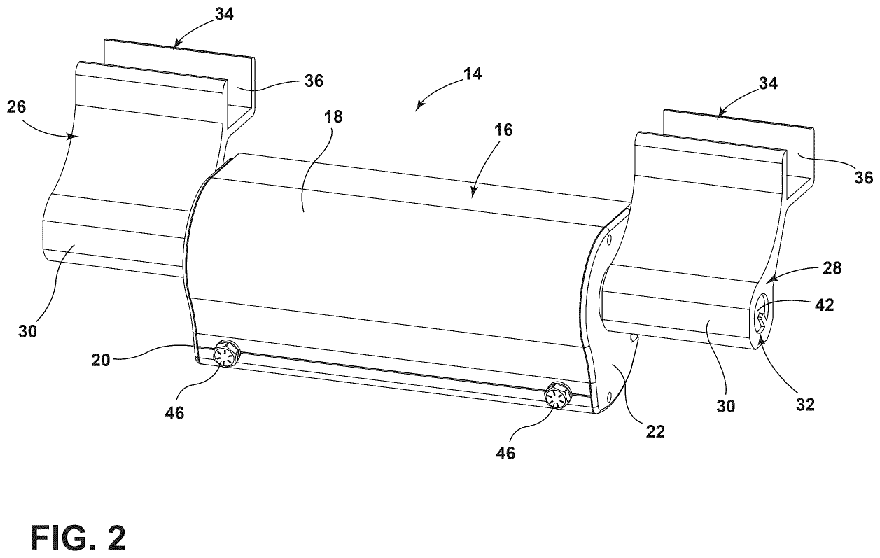

FIG. 2 is a perspective view of a hinge for use with the ramp door of FIG. 1.

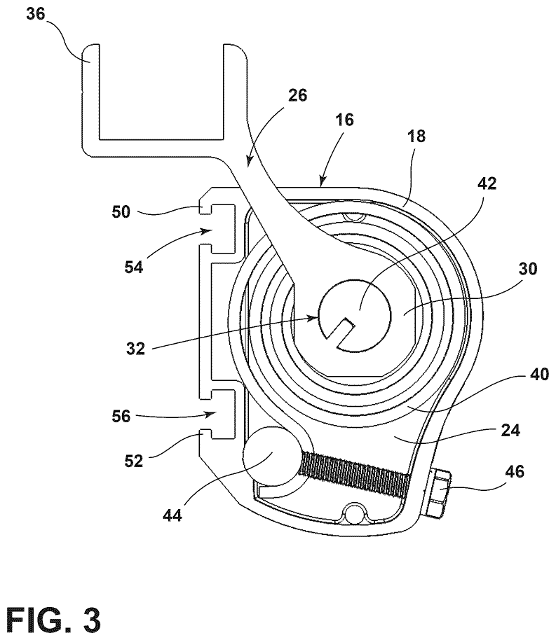

FIG. 3 is a cross sectional view of the hinge of FIG. 2.

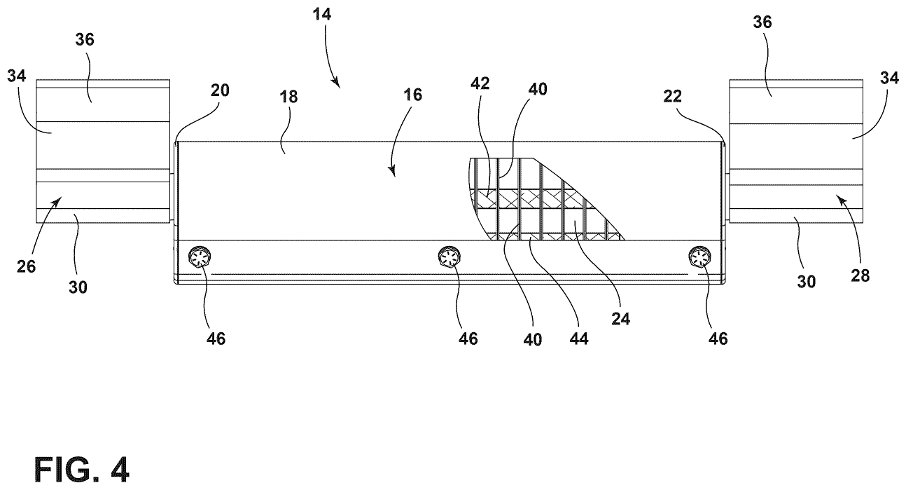

FIG. 4 is an elevational view of the hinge of FIG. 2 having a cutaway portion.

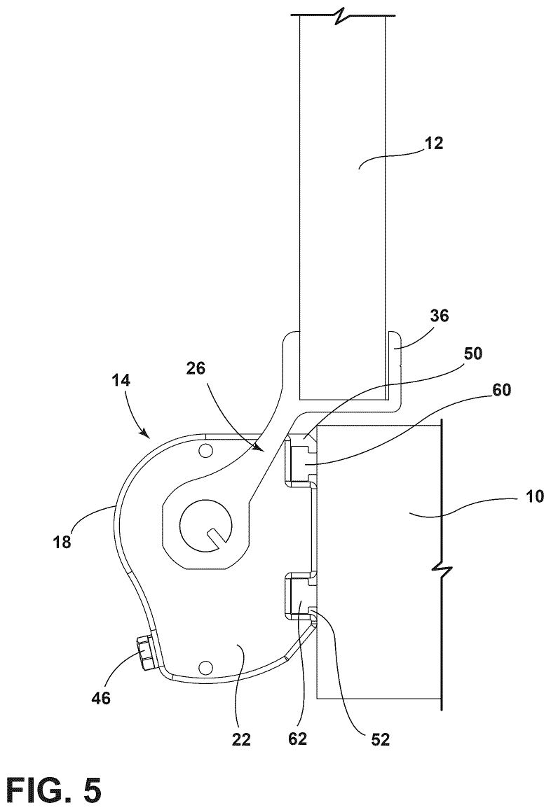

FIG. 5 is an elevated view of the hinge of FIG. 2 connected to a ramp and trailer.

### DETAILED DESCRIPTION OF THE PREFERRED EMBODIMENT

FIG. 1 depicts a portion of a trailer 10, which has pivotally connected to it a ramp 12, which may also be a door for the trailer 10. The pivotal connection is achieved by the use of a hinge 14.

As shown in FIGS. 2-4, the hinge 14 includes a case 16. The case 16 includes a housing 18, a first end plate 20, and a second end plate 22, which together define a hollow interior portion 24. Each end plate 20, 22, which may be referred to as “caps,” has an aperture therein configured to receive a rod. The aperture may be defined by a round bushing (not shown), such as a bronze bushing, which is in engagement with the end plate. The case 16 is configured to be fixedly attached to the trailer 10, such as by welding or by fastening with bolts. The case 16 keeps internal components free from debris and outdoor elements and may be made of any rigid material, but is preferably of a metal such as aluminum.

Located on opposite sides of the case 16 are a first outer member 26 and a second outer member 28. Each outer member 26, 28 has a base 30 with a hole 32 therethrough configured to receive and retain a portion of a rod. Connected to the base 30 is a flange 34 with a U-shaped member 36. The U-shaped member 36 is sized and shaped to receive a portion, such as a rail, of the ramp 12. The outer members 26, 28 may be of any rigid, durable material but are preferably of a metal such as aluminum.

Residing in the case 16 is at least one torsion spring 40 (see FIGS. 3 and 4), such as a spiral torsion spring. It is preferable that a plurality, such as five, ten, or fifteen springs 40 are employed. The number of springs 40 used is dependent on the load capacity desired. Thus, any number of springs may be used. The springs are preferably of steel, but may be any durable substance, especially metal.

Each spring 40 is connected to two rods 42, 44. The rods are preferably made of steel, but may be of any rigid material. The upper rod 42 is a centralized rod and is attached to each outer member 26, 28, via the hole 32 in each outer member. The lower rod 44 is attached to a first end of each torsion spring 40 which is opposite a second end attached to the upper rod 42. The first end of the spring 40 has a hook structure which assists in retaining the lower rod 44 in the housing 18.

The lower rod 44 is also connected to a plurality of adjusters 46, such as torsion screws, which can be tightened to add more tension or to pre-load each spring 40. The torsion screws may include a lock washer (not shown) or other mechanism for stability. This feature is beneficial if the ramp 12 is a heavier ramp door or has weight added to it.

As shown in FIG. 3, the housing 18 includes C-shaped portions 50, 52, which define channels 54, 56, respectively. The channels 54, 56 are shaped and sized to receive connection members, such as connection bars 60, 62 depicted in FIG. 5. Connection bars 60, 62 are rigidly attached to the trailer 10, specifically such as a frame thereof.

Depicted in FIG. 5 is the ramp 12 being received by the U-shaped member 36 of one of the outer members 26. The ramp 12 is preferably rigidly attached to the U-shaped member 36 such as by means of a fastener such as a nut and bolt or by welding.

It is contemplated that the hinge 14 could be manufactured and used without the housing 18. Omitting the housing 18 would reduce cost and weight of the hinge 14, but would subject various components of the hinge, including the springs 40, to the elements.

In operation, when the ramp 12 is in an upright position, the springs 40 are in a “free state,” that is, without tension or only pre-loaded tension as a result of use of the adjusters 46. When the ramp 12 is rotated downwardly, the motion will cause each outer member 26, 28 to rotate, in turn causing the upper rod 42 to rotate which rotates the inner portions of each of the springs 40. This rotation of the inner portions of the springs 40 causes the springs to be biased back toward the free state. Such bias results in the ramp 12 being easier for the user to lift the ramp 12 back to the free state once it is desired to return the ramp 12 to the upright position.

The above-described hinge 14 provides ease of lifting of a ramp for a user and provides adjustability for situations when a ramp has weight added to it or is heavier than a standard ramp.

1. A hinge comprising:
a housing defining an interior space, the housing comprising at least one wall member having an exterior surface and an interior surface;
at least one outer member adjacent the housing, the at least one outer member having an aperture therethrough;
a centralized rod, a portion of which resides in the interior space of the housing, and extending to and through the aperture of the at least one outer member;
a plurality of torsion springs in the interior space of the housing and connected to the rod; and
at least one fastener configured to adjust tension in at least one of the plurality of torsion springs.

2. The hinge according to claim 1, and further comprising a connection rod, the connection rod in engagement with at least one of the plurality of torsion springs and in engagement with the at least one fastener.

3. The hinge according to claim 1, wherein the at least one outer member has a U-shaped portion configured to receive a part of a trailer ramp.

4. The hinge according to claim 3, wherein the part of a trailer ramp is a rail.

5. The hinge according to claim 1, wherein the at least one outer member is a first outer member and the hinge comprises a second outer member adjacent the housing and positioned near a side of the housing opposite the first outer member.

6. The hinge according to claim 1, and further comprising an inner shell, the plurality of torsion springs being in engagement with the inner shell.

7. A trailer ramp connection apparatus comprising:
a central rod;
at least one spring in torsional engagement with the central rod;
an adjustable device comprising a rotatable member which is connected to the at least one spring, wherein rotation of the rotatable member changes the torsion in the at least one spring; and
a connection member connected to the central rod and configured to attach to or receive a portion of a trailer.

8. The trailer ramp according to claim 7, wherein the connection member comprises an end portion which is U-shaped.

9. The trailer ramp according to claim 7, wherein the connection member is a first connection member and the trailer ramp connection apparatus further comprises a second connection member configured to attach to or receive a portion of a trailer.

10. A vehicle trailer comprising:
a frame;
a ramp member connected to the frame; and
a hinge connection comprising:
a central rod,
at least one spring in rotational engagement with the central rod,
an adjustment device for adjusting tension of the at least one spring, and
a connection member connected to the central rod, the connection member in engagement with the frame or the ramp member.
